(19) United States
(12) Patent Application Publication
(10) Pub. No.: US 2010/0005041 A1
(43) Pub. Date: Jan. 7, 2010

(54) MACHINE LEARNING BASED VOLUME DIAGNOSIS OF SEMICONDUCTOR CHIPS

(75) Inventor: Seongmoon Wang, Princeton Junction, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/269,380

(22) Filed: Nov. 12, 2008

Related U.S. Application Data
(60) Provisional application No. 61/078,571, filed on Jul. 7, 2008.

(51) Int. Cl. G06F 15/18; G06F 17/50

(52) U.S. Cl. 706/12; 716/7; 716/5

(57) ABSTRACT

A system and method for integrated circuit diagnosis includes partitioning an integrated circuit design into sub-regions according to a structure of the integrated circuit design. A decision function is generated for a sub-region by training a machine learning tool. A sequence of test patterns is applied to a device under test (DUT) to determine responses. If the DUT fails, all the decision functions are evaluated with the errors produced by the DUT. A sub-region whose decision function yielded a highest value is selected to find a defect sub-region in the DUT.

### RELATED APPLICATION INFORMATION

This application claims priority to provisional application Ser. No. 61/078,571 filed on Jul. 7, 2008, incorporated herein by reference.

### BACKGROUND

1. Technical Field

The present invention relates to machine learning and more particularly to systems and methods for machine learning based volume diagnosis of semiconductor chips.

2. Description of the Related Art

Reducing time to ramp up yield is crucial for the profitability of semiconductor manufacturers. Even after the process has been stabilized, process excursion can also reduce yield. For 45 nm technology and below, traditional yield learning techniques such as in-line inspection and memory bitmapping are less effective due to small features and large numbers of metal layers.

Volume diagnosis methods, which are based on scan diagnosis, have attracted attention recently. Volume diagnosis uses manufacturing test data to locate defects. Hence, for successful volume diagnosis, the capability to process large volumes of data in a reasonable time is a key requirement. Since diagnosis is preformed in line with test applications, volume diagnosis can significantly increase test time and reduce throughput. The objective of diagnosis is to find systematic defects from statistical data collected by diagnosis processes.

Compressing output responses produced by devices under test during test applications is inevitable for volume diagnosis. Test data compression is already widely used even for test cases where volume diagnosis is not applied. Almost all output compression techniques employ lossy compression. Hence, diagnostic resolution can be severely affected by loss of information due to lossy compression.

A typical scan diagnosis flow starts with finding scan cells that capture errors. Then, locations of possible defects, often called candidates, are identified by cause-effect or effect-cause diagnostic analysis. Due to loss of information, accurately identifying error capturing scan cells is difficult. As a consequence of ambiguity identifying error capturing scan cells, the number of candidate defects increases fast as the compression ratio increases.

All published scan diagnosis techniques try to locate defect signal lines. These techniques roughly consist of three steps. The first step is to identify scan cells that capture errors for each failing test pattern. When output responses are compressed, there always exists some ambiguity: the higher the compression, the more ambiguity. Others have tried to reduce ambiguity by using circuit structure information, but accurately locating error capturing scan cells is very difficult, if not impossible, even with these techniques. The next step is to locate suspicious signal lines. If it is assumed only stuck-at faults are used, then we can still locate acceptable sizes of candidate defect signal lines by cause-effect diagnosis methods at high compression. However, there are many defects that do not manifest themselves as faults other than stuck-at faults. Using a cause-effect diagnosis method for large designs is unacceptable fault independent diagnosis due to its prohibitive run time and memory usage.

For example, a known technique (SLAT) can locate defect signal lines independently of defect type with reasonable time and memory usage. However, SLAT-based diagnosis ends up with a very large number of candidate signal lines at high compression due to the ambiguity of the first step result. It's a garbage-in garbage-out situation. The final step is to rank candidate defects, the most likely defect signal lines to the least likely defect signal lines. This step is mainly a series of intelligent guesses. Obtaining meaningful statistical information from this kind of data requires a lot of empirical study.

### SUMMARY

A system and method for integrated circuit diagnosis includes partitioning an integrated circuit design into sub-regions according to a structure of the integrated circuit design. A decision function is generated for a sub-region by training a machine learning tool. A sequence of test patterns is applied to a device under test (DUT) to determine responses. If the DUT fails, all the decision functions are evaluated with the errors produced by the DUT. A sub-region whose decision function yielded a highest value is selected to find a defect sub-region in the DUT.

A system and method for integrated circuit diagnosis includes generating a decision function for sub-regions of a device under test (DUT) by training a machine learning tool, applying a sequence of test patterns to the DUT to determine responses, if a test pattern fails, transforming responses into errors, evaluating decision functions for sub-regions in the sub-circuit that produced the errors, and selecting a sub-region whose decision function yielded a highest value to find a defect sub-region in the DUT.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for training a machine learning system to perform a diagnosis of a device under test and for conducting volume diagnosis with trained data and errors produced by a failed device under test in accordance with an illustrative embodiment;

FIG. 2 is a diagram showing a device under test for illustrating faults belonging to a same fanout free region;

FIG. 3A is a diagram showing support vector classification which may be employed in accordance with one embodiment;

FIG. 3B is a diagram showing an input space with inseparable data and a diagram showing the mapping of data of the input space into dot product feature space;

FIG. 4 is a diagram showing a partition structure of a device under test having scan slices and scan slice cone sets in accordance with one embodiment; and

FIG. 5 is a diagram and table for demonstrating training including fault injection, unique error signature sets and training data.

### DETAILED DESCRIPTION OF PREFERRED EMBODIMENTS

In accordance with the present principles, a machine learning technique for fault diagnosis is disclosed. Machine learning is widely used for data mining applications, which process a large amount of data. In accordance with one illustrative embodiment, first, the design is partitioned into a large number of small areas according to the structure of the design. Each partitioned area or sub-region is defined as a class for machine learning. Training is done with (compressed) output responses produced by simulating a large number of faulty designs, each of which has an injected fault at a different area. Faulty designs that have defects at the same class produce similar output responses. Results of training, which are basically a set of decision functions (one decision function is formed for each class or sub-region), are saved into files for diagnosis.

During a test application, compressed output responses to all test patterns are saved. If a device under test (DUT) fails the test, the saved output responses for the device under test are transferred for diagnosis. The diagnosis process of the present methods evaluates a set of decision functions. The class for which the decision function returns a largest value among the all decision functions with the output response is the defect area. Compared to the three steps of other diagnosis techniques, which require time consuming processes, the present diagnosis is much simpler and faster. It is not even necessary to evaluate all decision functions when hierarchical learning is employed, e.g., first locating a large defect area and then locating a defect small area within the large area.

Instead of locating defect signal lines, which are too small to locate accurately by compressed data, we locate a small defect area. Hence, it is much easier to locate a defect area accurately even with compressed data. It is not necessary to locate defect signal lines like other methods, nor is locating defect signal lines instead of areas better in terms of collecting useful statistical information for identification of systematic defects. Verifying whether the defect really exists at the diagnosed area (whether locating defect areas or defect signal lines) can be done only by an inspection procedure using scanning electro-microscopy (SEM), E-beam inspection, or other inspection equipment. Since the defect area located by the present methods is very small, it is within the scope of inspection equipment. Hence, there is virtually no loss of statistical information for yield learning.

Since the present methods reduce the time consuming diagnosis steps to evaluating decision functions, it's less complex and much faster. This makes in-line diagnosis feasible. Machine learning is widely used for applications that process huge volumes of data such as data mining. Training, which may need high run time complexity, is only one time effort and can be done independently of manufacturing steps. Since the present methods give a very small number of candidate defect areas even with very highly compressed test data, more meaningful statistical data can be collected for yield learning.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

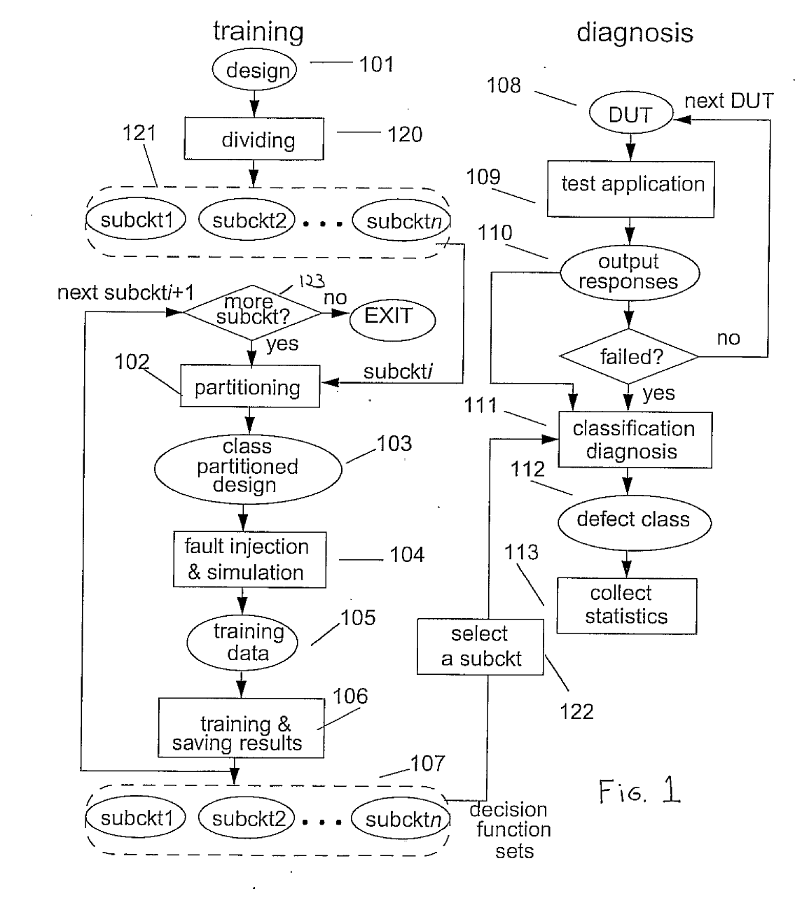

Referring now to the drawings in which like numerals represent the same or similar elements and initially to FIG. 1, a training and diagnosis block/flow diagram is illustratively shown. In block 101, a design for a semiconductor chip, circuit or other hierarchical design is provided. If the design is large, then the design is divided into sub-circuits (sub-components), e.g., according to the structure of an output compactor or based on other structure design features, in block 120. The design or sub-circuit is divided into smaller sub-regions, in a partitioning step 102. The partitioning may be performed in accordance with rules or constraints or in accordance with the design (sub-circuit) structure, e.g., fanout free regions. Each sub-region is defined as a class for training. In block 103, a class (sub-region) partitioning design results.

Dividing 120 the design into sub-components (sub-circuits) is different from partitioning 102 into sub-regions. A sub-region is defined as a class for training. Each sub-component/sub-circuit includes many sub-regions. The design is divided into sub-components to reduce memory usage and run time, e.g., if generating decision functions for the entire design needs too much memory space and evaluating all decision functions will take a long diagnosis time. By dividing 120 the design into sub-components (this is a hierarchical approach), we do not have to evaluate all decision functions or generate decision functions for all sub-regions (classes) in the design.

In block 104, several faults are injected into the sub-regions. Output responses from each fault injected design are collected to generate training data 105 for each sub-circuit (subcktᵢ). In block 106, training is performed separately with training data for each sub-circuit (subcktᵢ) and results of training are saved into a file in block 107. If the design was divided in sub-circuits, training results of each sub-circuit are saved into a separate file in block 107. The training includes assigning a decision function to each sub-region using machine learning, as will be described in greater detail below. The file 107 will be employed in a diagnosis flow. In block 123, a check to determine whether all sub-circuits have been processed is made. If all have been processed the training portion terminates. Otherwise, the training process continues with the next sub-circuit.

The diagnosis flow includes providing a device under test (DUT) in block 108, which may include a semiconductor chip, or similar circuit or device. A set of test patterns is applied to the device under test (DUT) 108 in block 109. Output responses from the DUT 108 are stored in block 110. If the DUT fails a test pattern in block 114, sub-circuits/sub-components are found/selected that produce errors in block 122, and a classification diagnosis is conducted by loading training results for the sub-circuits that produced errors (from block 107) and decision functions are evaluated in block 111 to determine the defect sub-regions of the sub-circuit. The defect sub-regions (e.g., fanout free regions) are found, e.g., by selecting the class (sub-region) whose decision function returns the largest value in block 112. Statistics on defect trends are collected from all diagnosis results in block 113.

In accordance with the machine learning based diagnosis, several techniques are employed for efficient training. Raw output responses produced by faulty designs are transformed for fault type independent diagnosis, and faults are injected into sub-regions (e.g., fanout free regions). Due to the special characteristic of fanout free regions, faults injected into the same fanout region produce similar behavior (captured into common scan cells).

To cope with memory blowup, which may occur in large designs, the design is partitioned or divided into smaller sub-circuits according to a compactor structure (scan slices) or other criteria (see block 120). Advantageously, machine learning is employed for volume diagnosis of semiconductor defects. Machine learning replaces the time consuming and obscure (due to loss of information caused by test data compression) diagnosis procedures. The diagnosis procedure in accordance with the present principles includes evaluating decision functions.

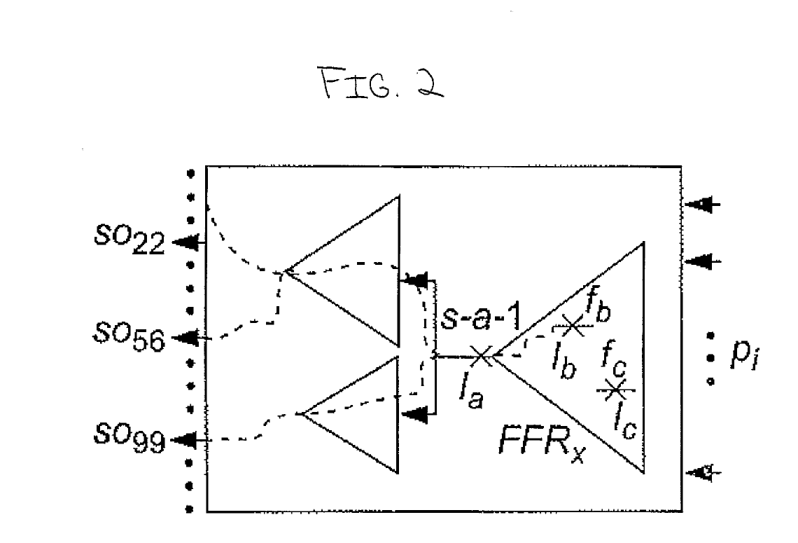

Referring to FIG. 2, a diagram illustratively depicts faults belonging to a same fanout free region. Consider the stuck-at-1 (s-a-1) and the stuck-at-0 (s-a-0) fault at circuit line l. Although test patterns that detect the s-a-1 fault never detect the s-a-0 fault and vice versa, there will be several common scan cells that capture errors of both the s-a-1 and the s-a-0 fault, in different test patterns. Likewise, some scan cells that capture errors of the stuck-at faults at l will capture errors of bridging defects at l. Even if conditions to activate defects are different, once activated, fault effects of defects at the same circuit line will propagate through similar paths and be captured into some common scan cells. This commonality in failing scan cells among defects at the same circuit line can be extended to defects in the same area, which has a specific property described hereinafter.

In FIG. 2, assume that test pattern pᵢ detects the s-a-1 fault at circuit line lₐ, which is the output of fanout free region FFRₓ. The activated fault effect at lₐ propagates to scan outputs so₂₂, so₅₆ and so₉₉ through internal circuit lines. Faults ƒ_{b} and ƒ_{c} are located inside FFRₓ. Assume that pᵢ sensitizes the path from l_{b} to lₐ (the output of FFRₓ), i.e., any fault effect at l_{b} propagates to lₐ. If ƒ_{b}, no matter what type of fault it is, is activated by pᵢ, then the fault effect of ƒ_{b} propagates to exactly the same scan cells in which the fault effects ƒₐ are captured.

In FIG. 2, ƒ_{c} is not activated by pᵢ. However, if there are other test patterns that activate ƒ_{c} and sensitize the path from l_{c} to lₐ, then many of the scan cells that capture fault effects of ƒ_{b} when pᵢ is applied will also capture fault effects of ƒ_{c}. When output responses are compressed (assume that output responses are compressed by space compaction), most fault effects of defects that are located in the same fanout free region will propagate to the same output compactors and observed at the same scan cycles.

As described above, there will be strong correlations among sets of scan cells that capture fault effects of defects that are located in the same fanout free region. This property permits machine learning to classify defective chips according to their defect locations (e.g., in fanout free regions). Training is performed with possibly compressed output responses that are produced by different faulty circuits, which are made by injecting faults into each class (fanout free region) in the circuit, and fault simulating them with a given set of test patterns. Sizes of classes determine diagnostic resolution of the present method.

According to our extensive experiments, most fanout free regions are small (e.g., include only 2-4 gates). Large fanout free regions can be split into smaller areas to enhance diagnosis resolution. During manufacturing tests, all failing output responses (output responses that do not match expected good circuit output responses) of failing chips are collected as input data to a machine learning tool.

Even though the present methods locate defect areas rather than defect circuit lines, since defined areas are small, we can easily pinpoint defects with scanning electro microscopy (SEM), E-beam inspection, or other inspection equipment. Even with traditional diagnosis methods, it is necessary to inspect candidate defects to verify if a defect really exists at one of candidate circuit lines (unless the diagnosis returns only one candidate defect with very high certainty). Locating one highly suspicious area is more useful than locating several suspicious circuit lines. If the number of candidate circuit lines is large and these circuit lines are at a distance from each other, then the inspection task will be very time consuming.

Statistical information can be obtained from the classification (also diagnosis) results without further processing data. This statistical information can be used to tentatively quantify systematic defects and random defects prior to detailed inspection such as SEM, e.g., classes (fanout free regions) that have large populations may include systematic defects while classes that have small populations may include random defects. Since defect inspection is very time consuming, the number of dies that can be inspected should be limited. Classification data can be used to guide the sampling process such that defective chips that best represent other chips in each class can be selected for SEM review.

Support Vector Machine (SVM): Defective chips may be classified using available machine learning software packages, such as, e.g., MiLDe. MiLDe is an integrated development environment with a suite of machine learning tools. However, in this disclosure, we use only the Support Vector Machine (SVM) tool of MiLDe for illustration purposes. The SVM is a training algorithm for classification and regression. Support Vector Classification (SVC) searches for an optimal separating surface, i.e., the hyperplane that is equidistant from a pair of classes.

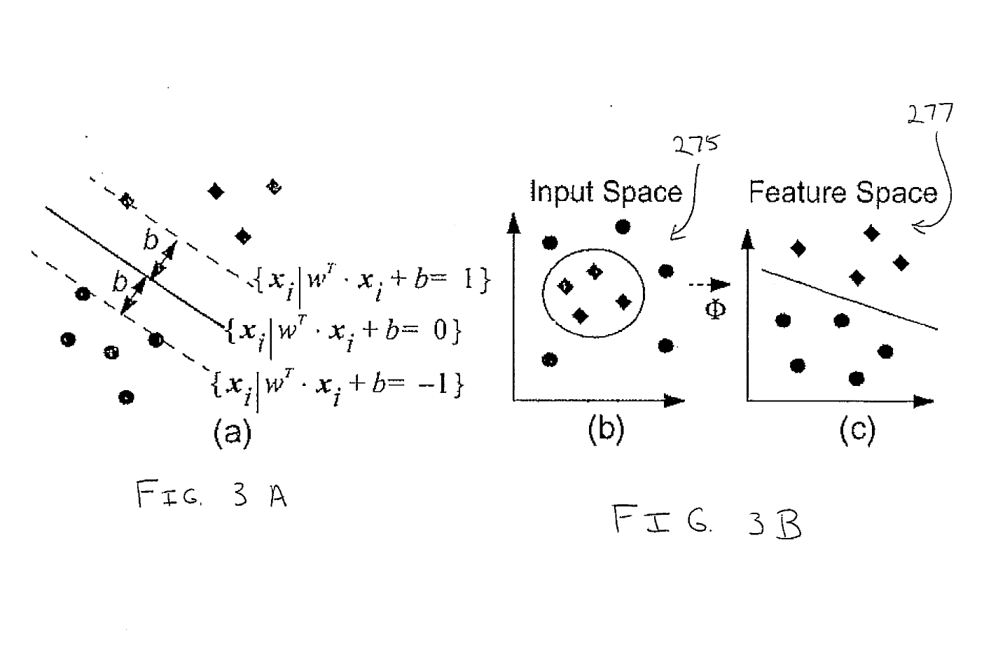

Referring to FIG. 3A, a 2-class classification problem is described that separates balls from diamonds in the graph. Let us label each training data (balls and diamonds), and assume that balls and diamonds are linearly separable, i.e., there are separating hyperplanes. The points x that lie on a hyperplane satisfy w^{T}·xᵢ=b=0, where w is normal to the hyperplane and bε [symbol] . If the training data are linearly separable, then there exits a pair (w, b) such that:

w^{T}·xᵢ+b≧1,∀xᵢε{diamonds}

w^{T}·xᵢ+b≦−1,∀xᵢε{balls} (1)

with decision functions ƒ(xᵢ)=sign(w^{T}·xᵢ+b). There can be an infinite number of separating hyperplanes. The optimal separating hyperplane is defined as the one that has maximal margin between the two classes.

There are problems that cannot be linearly separable. For example, FIG. 3B shows an example of an inseparable two-class classification problem. A trick is used to generalize the case where the decision function is not separable. FIG. 3B illustrates the basic idea of SVM for solving inseparable classification problems. The data in input space 275 are mapped into some other higher dimensional space F, called a feature space 277, via a nonlinear mapping Φ: [symbol] →F.

After the data mapping, decision functions are in the form of dot products Φ(x)·Φ(y). If F is high-dimensional, mapping data to F is time consuming and needs a large memory space. If there is a kernel function K such that K(x, y)=Φ(x)·Φ(y), we need to compute only K in the training function without explicitly performing the mapping. We need not know even what Φ is. Polynomial kernels, Radial Basis Function (RBF) kernels, and sigmoid kernels are widely used among SV practitioners.

SVM Training: The training process of the diagnosis technique as described with respect to FIG. 1 will be described in greater detail. In SVM, each class (or sub-region) needs a separate decision function. In the present diagnosis method, training data are prepared from output responses generated from faulty versions of the design, which are created by injecting faults into each of fanout free regions. Note that target objects of the present diagnosis technique are defect fanout free regions. Since most fanout free regions are small, a typical million gate design can have hundreds of thousands of fanout free regions. The total memory usage of an SVM tool is determined by the number of decision functions. Hence, building decision functions for all fanout free regions for a million gate design at once can blow up memory.

Circuit Partitioning: Referring to FIG. 4, to avoid memory blow-up and also reduce run time complexity of diagnosis, we partition the design of DUT 202 into many sub-circuits SO₁, SO₂, . . . SO₂₅, each of which is much larger than even the largest fanout free region, according to an output compaction structure (including an output compactor 204, e.g., XOR trees to compress output responses) of the design and conduct training for each sub-circuit separately.

A cone set is a set of circuit cones that drive scan cells that belong to the same scan slice. A fanout free region is a region of a circuit that includes gates that have no fanout branches. Fanout branches of a gate are circuit lines that branch from the output of the gate.

For the partitioning process, we assume that output responses captured in scan cells are compressed by space compaction before they are observed through external scan output pins as shown in FIG. 4. A set of scan cells (q) whose values are scanned out through a common compactor 204 at a same scan shift cycle is called a scan slice (ss). In FIG. 4, since values captured in scan cells, q₁, . . . , q₄ are scanned out at the same scan cycle through the same external scan output pin, scan cells q₁, . . . , q₄ belong to the same scan slice, ss₁. Scan cells q₆, . . . , q₈ compose another scan slice. The four scan cells (q) in each scan slice (ss) capture faults in corresponding four circuit cones (c, e.g., c₁, c₂, c₃, c₄ for the first scan slice ss₁). The set of circuit cones (e.g., c₁₋₄) whose outputs drive scan slice ssⱼ is called the circuit cone set or simply cone set of ssⱼ and denoted by csⱼ. Although only two circuit cones overlap with each other in FIG. 4, in reality each circuit cone can overlap with many other circuit cones not only in the same cone set but also in other cone sets. Since training is performed for each cone set (sub-circuit) separately, if there are a cone sets of concern (if there are cone sets that are known to be systematic defect free, it is not necessary to train for these cone sets) in the design, then we need α different training processes.

In one example, a sub-region is defined as a class. We define each class by partitioning the design into sub-regions (fanout free region). This is necessary for training. Basically, the finest diagnosis resolution is a sub-region. We train each sub-circuit separately, but all sub-regions in the same sub-circuit are trained at the same time. Note that dividing a design into smaller sub-circuits is optional. It is for avoiding memory blowup and diagnosis time reduction. If the design is small, this step is not necessary.

Preparing Training Data: In one example, preparing training data starts with identifying fanout free regions in each cone set. Each fanout free region is defined as a class for training; all faulty versions of the design that have faults in the same fanout free region belong to the same class. Output responses of each faulty version are collected by fault simulating the responses with test patterns to be applied during test application. Raw output responses generated by each faulty version are transformed to improve learning efficiency. First, each w·l-bit output response, where w is the number of external scan outputs of the design and l is the scan depth of the design, i.e., the number of scan cells in the longest scan chain, is transformed into a w·l-bit error signature, which is derived by XORing the output response with its corresponding expected output response.

Hence, if a faulty version of the design, νₐ, produces an error at the k-th output, i.e., the value at the k-th external scan output of νₐ is different from the expected value at the k-th output, when test pattern pᵢ is applied, the k-th bit of the error signature for pᵢ is assigned a 1 in the error signature for pᵢ. Otherwise, it is assigned a 0. If test pattern pᵢ does not detect the fault injected in νₐ, the error signature for pᵢ is all zero.

Using error signatures directly as training vectors can confuse the training process. Consider two different faulty versions νₐ and ν_{b} of a design, which have respectively the s-a-0 fault and the s-a-1 fault at the same circuit line l. Even though the two versions have a fault at the exactly same location, their error signatures to each test pattern are significantly different; when νₐ produces errors, ν_{b} produces no errors and vice versa. However, if we compare bit locations of the two faulty versions' error signatures that are assigned 1's, there will be similarities between them since the location of the faults is the same (many scan cells that capture errors of the s-a-0 fault will also capture errors of the s-a-1 fault). Error signatures are transformed into another format to consider this fact as described below.

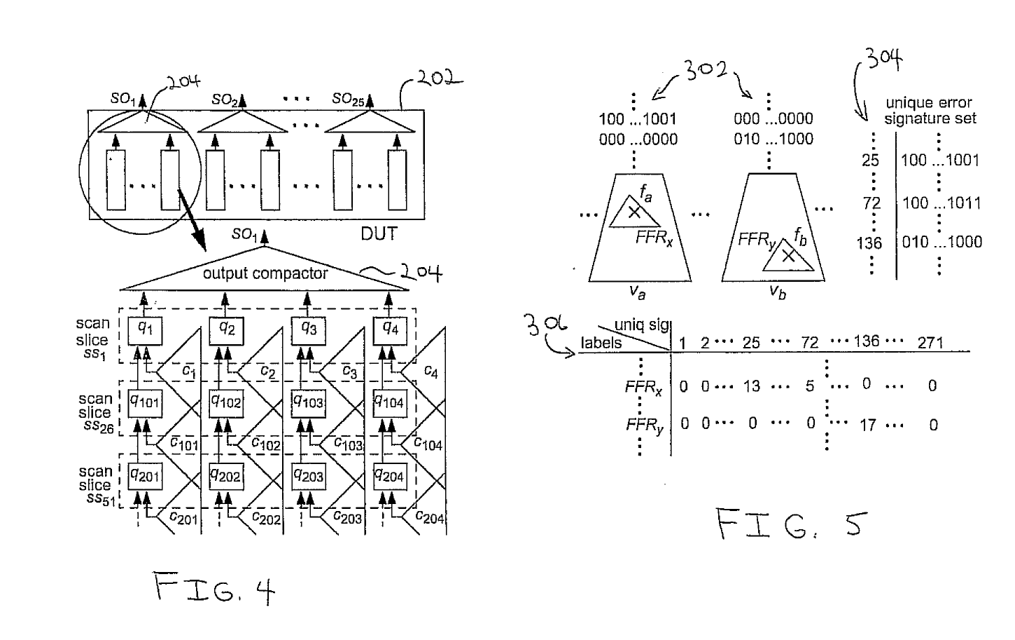

Referring to FIG. 5, an illustrative transformation procedure is described. Assume that faulty version νₐ is made by injecting fault ƒₐ and another fault version ν_{b} is made by injecting fault ƒ_{b}. Once error signatures for output responses 302 of all faulty versions to all test patterns are generated, we collect only unique error signatures from all error signatures. A unique index number is given to each error signature in the collected unique error signature set as shown in table 304. For example, index 25 (or 72) is given to the error signature 100 . . . 1001 (or 100 . . . 1011). Finally, a training vector is created for each faulty version of the design using the unique error signature set and its error signatures. A table 306 shows the training data set, which is converted from the error signature set 302. Each row corresponds to a faulty version of the design, e.g., a training vector for MiLDe SVM tool.

Table 306 shows training vectors for two faulty versions, νₐ and ν_{b}. The class labels for νₐ and ν_{b}, are different since the faults injected for νₐ and ν_{b} are located in different fanout free regions (FFRₓ, and FFR_{y}, respectively). The training vector for νₐ has 13 class labels at the column labeled “25” and 5 labels at the column labeled “72”. This means that νₐ produces error signature 100 . . . 1001 (index 25) for 13 test patterns and produces error signature 100 . . . 1011 (index 72) for 5 test patterns. Likewise, ν_{b} produces error signature 010 . . . 1000 (index 136) for 17 test patterns.

The MiLDe SVM tool reads the prepared training data for each cone set and performs training. Training results (decision functions) for each cone set are saved into a separate file.

Volume Diagnosis: If a chip fails during a test application, output responses produced by the failed chip are transferred for diagnosis. First, scan slices that capture errors are identified. Assume that there exists only one defect (in a fanout free region). Since there is only one defect fanout free region, cone sets of all scan slices that capture errors include the defect fanout free region. Hence, we can arbitrarily select the cone set of any scan slice among these scan slices and locate the defect fanout region.

Next, the output responses produced by the failed chip are transformed into the format shown in Table 306 of FIG. 5 by the same procedure used to prepare training data. The training results of the cone set of the selected scan slice are loaded along with the transformed output responses of the failed chip. The defect fanout free region is located by simply finding the fanout free region (class) for which decision function gives the largest value.

If there are multiple defects, there can be more than one defect fanout free region and these defect fanout free regions may distribute across multiple cone sets. Hence, selecting one scan slice arbitrarily may not locate all defect fanout free regions. A straightforward solution is to repeat the procedure for all scan slices that capture errors. If there are a large number of scan slices, we can select the best scan slices when diagnosing every scan slice that captures errors.

A novel volume diagnosis method uses machine learning techniques instead of traditional cause-effect and/or effect-cause analysis. Volume diagnosis uses manufacturing test data to locate defects. Hence, for successful volume diagnosis, the capability to process large volume of data in reasonable time is a key requirement. The present diagnosis technique exploits the fact that errors of faults in the same fanout free regions propagate through many common paths and observed at common scan cells. The present technique has several advantages over traditional cause-effect or effect-cause diagnosis methods, especially for volume diagnosis. In the present method, since the time consuming diagnosis process is reduced to merely evaluating several decision functions, run time complexity is much lower than traditional cause-effect or effect-cause diagnosis methods. Diagnosis time for the present method is negligible compared to typical test application time. The present technique can provide not only high resolution diagnosis but also statistical data by classifying defective chips according to locations of their defects (a standard formulation of machine learning is the classification problem). Even with highly compressed output responses, the present diagnosis technique can correctly locate defect locations for most defective chips. Since success or failure of each diagnosis is clearly known, even failed diagnoses do not corrupt defect statistics. Hence, more reliable statistical data can be obtained. Experimental results have demonstrated feasibility of the present technique. The present technique correctly located defects for more than 90% defective chips when 50× output compaction was employed. Even with 100× compaction, the present diagnosis technique was able to locate defect area correctly for more than 86% defective chips. Run time for diagnosing a single simulated defect chip was only a few milliseconds for most cases.

Having described preferred embodiments of a system and method for machine learning based volume diagnosis of semiconductor chips (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for integrated circuit diagnosis, comprising:
partitioning an integrated circuit design into sub-regions according to a structure of the integrated circuit design;
generating a decision function for a sub-region by training a machine learning tool;
applying a sequence of test patterns to a device under test (DUT) to determine responses;
if the DUT fails, evaluating all the decision functions with the errors produced by the DUT; and
selecting a sub-region whose decision function yielded a highest value to find a defect sub-region in the DUT.

2. The method as recited in claim 1, wherein the DUT is divided into sub-circuits and partitioning includes partitioning each sub-circuit into sub-regions.

3. The method as recited in claim 2, further comprising separately training classes for each sub-circuit.

4. The method as recited in claim 1, wherein the sub-regions include fanout free regions.

5. The method as recited in claim 1, wherein partitioning includes partitioning based on a design structure.

6. The method as recited in claim 1, further comprising, injecting faults into sub-regions to simulate errors in the design to train the machine learning tool.

7. The method as recited in claim 6, further comprising, capturing responses of a fault injected integrated circuit design and transforming responses to errors.

8. The method as recited in claim 1, further comprising storing generated decision functions in association with the sub-regions.

9. A method for integrated circuit diagnosis, comprising:
training a machine learning tool and generating decision functions for sub-regions of a device under test (DUT);
applying a sequence of test patterns to the DUT to determine responses;
if a test pattern fails, transforming responses into errors;
evaluating decision functions for sub-regions in the sub-circuit that produced the errors; and
selecting a sub-region whose decision function yielded a highest value to find a defect sub-region in the DUT.

10. The method as recited in claim 9, wherein errors are transformed into an index to a unique error vector array to make a diagnosis process fault type independent.

11. The method as recited in claim 9, further comprising storing generated decision functions in association with the sub-regions.

12. The method as recited in claim 9, further comprising dividing the DUT into sub-circuits and partitioning each sub-circuit into sub-regions.

13. The method as recited in claim 12, further comprising separately training decision functions for each sub-circuit.

14. The method as recited in claim 9, wherein the sub-regions include fanout free regions.

15. The method as recited in claim 12, wherein dividing includes dividing the DUT based on a compaction structure.

16. A computer readable medium comprising a computer readable program for integrated circuit diagnosis, wherein the computer readable program when executed on a computer causes the computer to:
partitioning an integrated circuit design into sub-regions according to a structure of the integrated circuit design;
generating a decision function for a sub-region by training a machine learning tool;
applying a sequence of test patterns to a device under test (DUT) to determine responses;
if the DUT fails, evaluating all the decision functions with the errors produced by the DUT; and
selecting a sub-region whose decision function yielded a highest value to find a defect sub-region in the DUT.
